(19) United States
(12) Patent Application Publication
(10) Pub. No.: US 2010/0297585 A1
(43) Pub. Date: Nov. 25, 2010

(54) PROCESS FOR MAKING A DENTAL RESTORATION AND RESULTANT APPARATUS

(76) Inventor: Uriel Yarovesky, Thousand Oaks, CA (US)

Correspondence Address: KELLY LOWRY & KELLEY, LLP, 6320 CANOGA AVENUE, SUITE 1650, WOODLAND HILLS, CA, 91367, US

(21) Appl. No.: 12/849,396

(22) Filed: Aug. 3, 2010

Related U.S. Application Data
(63) Continuation-in-part of application No. 12/360,460, filed on Jan. 27, 2009.
Application No. 12/360,460 is a continuation-in-part of application No. 12/115,967, filed on May 6, 2008.
(60) Provisional application No. 61/024,498, filed on Jan. 29, 2008.

(51) Int. Cl. A61C 13/007

(52) U.S. Cl. 433/199.1

(57) ABSTRACT

A process for making a dental restoration includes forming an image which represents a natural oral cavity characteristic. The image may be formed on a computer by an artist or by capturing a photograph of an oral cavity. The computer-based image may be modified with a computer-aided software program. The image is then transferred to a dental construct base and conditioned by a high intensity light or by being fired together in an oven. Thereafter, a sealant is disposed over at least a portion of the image or the dental construct substrate and finished to create a dental restoration having the desired oral cavity color and characteristics.

### BACKGROUND OF THE INVENTION

The present invention relates to a process for making a dental restoration and the resultant apparatus. More particularly, the present invention relates to a process for attaching or printing an image to a resultant dental appliance for creating a dental restoration having desired color and characteristics similar in appearance to natural teeth and/or oral tissue.

Dental restorations, in general, are fabricated to replicate the natural anatomical appearance in the oral cavity. This fabrication process is highly dependent on the artistic abilities of dental technicians. This dependence creates a difficulty among dental laboratory owners and dentists to produce consistent quality for patients. The reason for this difficulty lies in the fact that there are relatively few dental technicians that have the artistic ability or experience to artistically perform dental restorations to a level necessary to achieve high aesthetic results. This creates a high demand for experienced dental technicians and correspondingly drives up costs as there are few dental technicians with the requisite experience. Such high costs make it difficult for laboratories to stay competitive in a global market.

A current dental restoration trend is to use veneers, which are a thinner, more conservative tooth restoration. These restorations are applied with the dentist removing little or no natural tooth structure. The sacrifice for this type of restoration is that, while the natural tooth stays relatively intact, the thin structure of the veneer provides little to no room for the laboratories to create the natural aesthetics that are achieved using three dimensional color and structures. Many patients do not understand the anatomy of a tooth and do not understand the importance of these structures in making smiles appear natural. Most dentists understand the importance of preserving the natural tooth for the purpose of maintaining sound structure. For this reason, some dentists may choose to make any necessary changes using minimally invasive dentistry. But, dentists are forced to use these thin veneers because of mass marketing to the public. Some dentists provide these restorations only to meet patient demand.

Thus, there is a need in the art for a process for making a dental restoration, and resultant apparatus, having desired color and characteristics similar to the natural oral cavity of which is applicable to crowns, bridges, ceramic restorations, resin, denture teeth, veneers, pre-fabricated matrixes, pre-cured resins and composites, and any other kind of restorative dental appliance. The present invention fulfills these needs and provides further related advantages.

### SUMMARY OF THE INVENTION

The present invention is directed to a process for making a dental restoration and the resultant apparatus. The process for making the dental restoration includes the step of forming an image which represents a natural oral cavity characteristic. The natural oral cavity characteristic may include, for example, internal or external structures, coloration of teeth, oral cavity tissue, including, but not limited to, teeth, enamel, dentin, crazing lines, stains, veins, blood vessels, bony coloration, hyper-calcification, mucosal tissue or gum tissue of the patient undergoing the dental procedure.

In one embodiment, the image forming step may include creating the image on a computer. The computer-based image may include a computer-generated image, a digital photograph, or an imported artistic drawing. The computer-generated image may be created digitally by an artist. Alternatively, the image may be formed by modifying an existing digital photograph of an oral cavity. In one embodiment, the captured photograph is of the oral cavity of the patient receiving the dental restoration. In an alternative embodiment, the oral cavity photograph is that of another person and is modified with a computer-aided software program to obtain the desired natural oral cavity characteristic. Likewise, the computer-generated image and the photograph may be modified further to add a desired natural oral cavity characteristic. Moreover, an image or photograph of the projected finished oral cavity may be generated to allow the patient to view the result before commencing the restoration.

In another embodiment, the image forming step may include the step of fabricating a stock set of standard images representative of select natural oral cavity characteristics a patient may receive. In one embodiment, the stock set or compilation may be created on a computer. The images may be created digitally by an artist, by digitally capturing a set of existing photographs, by modifying a set of digital photographs of a series of actual oral cavities, or by compiling a series of images of other previously digitally mastered oral cavities. In this regard, a set of distributable pictures of the images may be created for viewing by the patient. The distributable picture may be used with a characterization guide to aid in the selection of a computer-based image. This allows the patient to choose a resultant oral cavity characteristic prior to commencement of the actual restoration.

The image may be printed directly to the tooth restoration to impart the desired natural oral cavity characteristic thereon during the transferring step. Alternatively, the image may first be printed to a substrate such as a film, a paper, a ceramic, or a wax substrate attachable to the dental construct base. Once the image is printed or attached to the dental construct base, the image and the dental construct base are conditioned to create a dental restoration having the desired oral cavity color and characteristics. The conditioning step may include the step of curing the image and the dental construct base or with a high intensity light or fusing the image to the dental construct base.

The process for making the dental restoration further includes the step of disposing a sealant over at least a portion of the image and/or at least a portion of the dental construct base for protection thereof. In ceramic application, the sealant may include a composite resin, a transparent acrylic resin, a protective layer, a ceramic, a glaze or a combination thereof. The sealant and the image and/or the dental construct base are finished through application of heat at a temperature at least approximately 120 degrees Fahrenheit lower than the temperature applied to the image and the dental construct base during the initial construction steps to prevent distortion due to heat. An additional secondary image may be printed or affixed to the sealant followed by a layer of glaze, if needed. The glaze is disposed over the sealant and the secondary image for protection thereof, if needed. The images may be placed internally to create additional three-dimensional visual effects and to protect the colors.

The resultant dental restoration apparatus includes a dental construct base preferably made from a composite resin, ceramic or an acrylic resin. A printed image imparted to the dental construct base has a natural oral cavity characteristic selectable with the characterization guide. The image is preferably printed from a computer-based image. The computer-based image may include a photograph, a computer-generated model image or a drawing. The natural oral cavity characteristic may be digitally painted to the computer-based image on a computer-aided software program and may include, for example, teeth, enamel, dentin, crazing lines, stains, veins, blood vessels, bony coloration, hyper-calcification, mucosal tissue or gum tissue. These natural oral cavity characteristics may be included in a stock of standard computer-based images representative of the natural oral cavity characteristics commonly found in corresponding dental restorations. A distributable picture of the computer-based images of the oral cavity of the patient matching the decals may also be provided so the patient and/or dentist may select the desired oral cavity characteristic prior to receiving the dental restoration with the characterization guide.

Similar to the dental construct base, the sealant may also be made from a composite resin, a transparent acrylic resin, a protective layer, a ceramic, or a glaze. Preferably, the dental construct base, the sealant and the image are all made out of the same material, such as a composite resin, a ceramic, or an acrylic resin. Furthermore, a secondary image may be affixed to the sealant. Here, a glaze is preferably disposed over the secondary image and the sealant for protection thereof. The image may be printed directly to the dental construct base or printed to a film, a paper, a ceramic, or a wax substrate attachable to the dental construct base.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a flowchart illustrating the process of producing and selecting a decal for use in a dental appliance;

FIG. 2 is a flowchart illustrating the process of incorporating a decal in a composite resin-based dental restoration;

FIG. 3 is a front view of a rebuilt chipped tooth having a decal therein;

FIG. 4 is cross-sectional view of a restored chipped tooth, including an external decal having an enamel composite resin layer thereover;

FIG. 5 is a flowchart illustrating the process of incorporating a decal into a veneer-based dental restoration;

FIG. 6 is a cross-sectional view of an internal decal incorporated into a dental restoration;

FIG. 7 is an alternative cross-sectional view of the dental restoration of FIG. 6, including an external decal for added color and characteristics;

FIG. 8 is a cross-sectional view of an external decal formed on a veneer before application to the veneer-prepped tooth;

FIG. 9 is a flowchart illustrating a process of incorporating a decal into a ceramic denture tooth, acrylic tooth, or composite tooth;

FIG. 10 is a cross-sectional view of a decal located between an enamel ceramic and a dentin ceramic in the ceramic and denture tooth;

FIG. 11 is a front view of a ceramic denture tooth having a decal located therein, illustrating detail lines and lobes;

FIG. 12 is a front view of a ceramic, acrylic, or composite denture tooth having a decal located therein, illustrating crazing lines and other characterizations;

FIG. 13 is a flowchart illustrating the process of incorporating a decal into an acrylic resin, composite or ceramic representing tissue in dentures;

FIG. 14 is a cross-sectional view of an internally placed decal representing the tissue area of dentures or other tissue incorporated devices; and

FIG. 15 is a cross-sectional view of an externally placed decal representing the tissue area of dentures.

### DETAILED DESCRIPTION OF THE PREFERRED EMBODIMENTS

The process for making a dental restoration and resultant apparatus described herein endeavors to allow dentists to continue offering conservative restorations without sacrificing the natural appearance of the restored tooth. The process makes use of directly printing an image to the dental restoration or placing a decal thereon. The printed image(s) and/or the decal(s) are designed to replicate the natural anatomical appearance of the oral cavity, such as tooth coloration, crazing lines, dentin, internal coloration, hyper-calcification, transparency, enamel variation, veins, white stains, lines in teeth, and other tissue and tooth colorations artistically difficult to replicate. The resultant restoration should replicate the natural appearance of a tooth without requiring laborious efforts or a skilled dental artist. The resultant apparatus has desired color and characteristics similar to the natural oral cavity of the patient undergoing the dental procedure. The restoration includes use of a dental construct substrate that may be used with copings, dental crowns, partial crowns, bridges, ceramic restorations, resin, partial or full denture teeth, veneers, pre-fabricated matrixes, pre-cured resins and composites, partially cured composites, and any other kind of restorative dental appliance. The process further allows patients to preview the final look before approving the procedure. The approval process mitigates costly restoration reconstructions because the patient has the opportunity to approve the final look before the restoration procedure begins. The process described herein also provides an easier way to redo a restoration in the event the patient wants to change the look after the dentist or technician performs the restoration. One of the main advantages is that the process is able to accurately produce a finished restoration that consistently matches the preview.

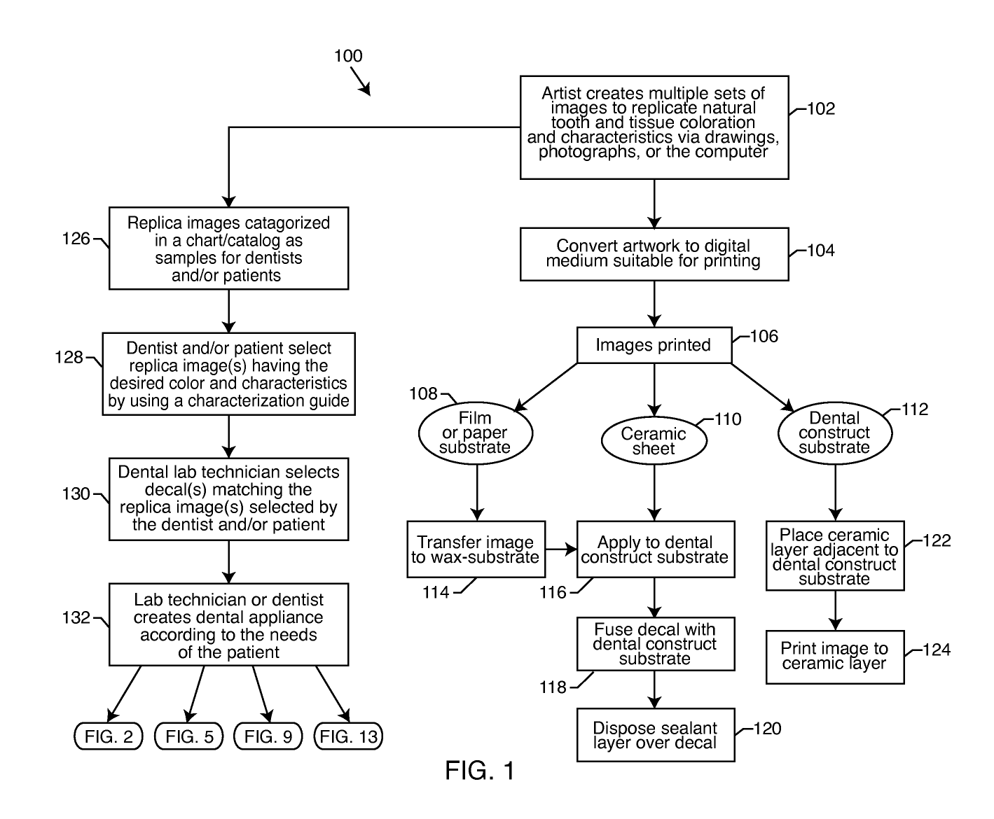

FIG. 1 illustrates a flowchart for a process of creating decals for placement in dental appliances (100). First, an artist creates multiple sets of images to replicate natural tooth and tissue coloration and characteristics (102). The images may be created via any one of a number of techniques that include manually drawing art work, photographs or computer generated images. In one embodiment, the decals may be made from artwork drawn out manually in a large format on an 8×10 sheet to provide accurate painted details of internal and external structures, characteristics and coloration of teeth and oral cavity tissue. The artist may choose to draw the images based on photos of the patient, general photos of models, or drawings of internal and/or external tooth and oral cavity tissue. Alternatively, the artist may photograph the teeth of the patient to be later printed and used as a decal. In this embodiment, the photographic image of the external structures, characteristics and coloration of the teeth and oral cavity tissue of the patient is not altered by the artist.

Furthermore, and as an exemplary embodiment, the artist creates a set of decals by manipulating images in a digital-based computer aided software program to obtain the desired color and characteristics. Here, the digital images may be photographs of the patient or photographs of another person. The images may also be developed from scratch by the artist with the related software program. The artist may manipulate the images through the computer aided software program to obtain the color and characteristics desired by the patient. Computer-based images are particularly useful because the artist can select from many base or standard images and make any modifications thereto. Likewise, photographs of the oral cavity of the patient can be manipulated digitally to add or remove color and characteristics to achieve the desired look. The objective is that the dentist or technician can produce the most realistic and accurate decal specific to each individual patient receiving a dental restoration. Accordingly, the decals may vary in style, color, characteristics and size, depending on the patient. The decals may include additional anatomical details such as mucosal tissue replication, veins, blood vessels, bony coloring, hyper-calcification, crazing lines or virtually any other natural or unnatural effects that affect tooth and oral cavity tissue color and characteristics. Appropriately, the decals will vary according to the application, patient and desired use.

Once the details of the artwork are complete, the artwork is reduced in size to the size of natural teeth in preparation for dental application and, if not done so already, the artwork is converted to a digital medium suitable for printing (104). The computer generated image(s) may be printed (106) to a film or paper substrate (108), a ceramic sheet (110) or directly to the dental construct substrate (112) without the use of a substrate or sheet. The film or paper substrate (108) preferably includes a film forming material that provides a backing for the decal. Examples of such substrates may include paper, coated paper, polymeric film, and soluble organic film. The substrate may or may not have an adhesive (such as a water-based adhesive) or glue thereon.

Next, the image may be transferred onto a wax substrate (114) by any method known in the art. For example, printed paper images may be roll heated to a wax mixture substrate. The image on the decal remains on the wax mixture substrate when the paper and wax mixture substrate are subsequently separated. The image on the wax mixture substrate may include various color pigments to help correct tooth discoloration. The color pigment may even be opaque to block unwanted discoloration in cases of severe discoloration. For example, the decal may block darker background portions of a tooth to achieve lighter and brighter results. Alternatively, the color pigments of the decal may introduce desired color and structures within this layer. The printed decals are capable of being fired or attached at recommended temperatures or other curing methods, for secure attachment to the desired dental prosthesis. The versatility of such decals is virtually unlimited and can be used to recreate any type of dental effect, both existing structures and non-existing structures in the oral cavity.

Alternatively, the image may be printed to a ceramic sheet (110) that may have a substantially transparent ceramic or glaze layer formed from a fine powder of ceramic materials. Dental glaze materials and dental glass-type (transparent or translucent) porcelain may also be used. Such dental glaze or porcelain materials generally include some of nephefine-syenite, silica, china clay, whitening agents, metal oxides, etc. The ceramic sheet may also contain some addictives or binders. The image printed to the ceramic sheet is applied directly to the dental construct substrate (116) using known methods. The ceramic print may replicate the entire tooth or just a portion of the tooth. The desired characteristics may be printed to the ceramic sheet in one pass or multiple passes. The thickness of the ceramic image layer should remain thin relative to the thickness of the original tooth.

An image or multiple images may be printed as a decal to either the film or paper substrate (108) or the ceramic substrate (110). The images may be printed using different metallic oxides to produce different colors. For example, a blue colorant may include oxides such as cobalt, chromium, aluminum, copper, manganese, zinc, etc.; a yellow colorant may include one or more oxides such as lead, antimony, zinc, titanium, vanadium, gold, etc.; a red colorant may include one or more oxides of chromium, iron (of two valence state), zinc, gold, cadmium, selenium, or copper; and a black colorant may include oxides of metals such as copper, chromium, cobalt, iron (plus two valence), nickel, manganese, etc. Alternatively, the printed images may use commercially available colored stains or compositions such as ceramic color compositions or non-toxic ceramic colorants. Composite and acrylic stains could be used for non-ceramic applications. Here, the decals are printed with resin-based colors, which are also non-toxic. Preferably, ceramic decals use ceramic colorants, composite decals use composite colorants and acrylic decals use acrylic colorants.

The printed image may include the aforementioned artistic workup, photograph, or digitally altered design replicating natural oral cavity color and characteristics. These images may be printed to one decal or a series of decals. The image on the decal may represent the color and characteristics of an entire tooth, or just a portion of the tooth. Accordingly, the dental restoration may receive a single decal representative of all the desired color and characteristics of the restoration or several decals, each designed to provide similar or somewhat different color and characteristics. Three-dimensional effects may be created when applying multiple decals in layers. The decal having the image(s) thereon should be flat, thin and pliable. Preferably, the thickness of the decal (or set of layered decals) should remain thin relative to the thickness of the overall dental restoration. The aggregate thickness of the decal(s) is preferably in the range of 4-6 microns or, alternatively, in the range of 0.1 to 2 mm.

Once the printed image is transferred to the wax substrate (114) or printed to the ceramic sheet (110), the decal is placed adjacent to the dental construct substrate (116) to be fused together (118). For example, the image may be transferred to a wax substrate or a substrate coated with a wax layer (108). In one embodiment, a heat transfer paper with a wax coating having a melt point in the range of 65 to 85 degrees Centigrade (° C.) may be used. Preferable heat transfer paper is described in detail in U.S. Pat. Nos. 6,126,669, 6,123,794, 6,025,860, 5,944,931, 5,916,399, 5,824,395, 5,032,449, the contents of each being herein incorporated by reference. Additionally, a food grade wax or candle wax may also be suitable. The wax-based substrate should also be thin and flexible to conform easily to the dental construct substrate. Even at higher thicknesses, a wax-based substrate may generally still conform to the dental construct substrate. Preferably, the transferred image on the wax-substrate is separated from the film or paper substrate prior to being placed adjacent to the dental construct substrate (116). The image and either the wax-based substrate or the ceramic substrate are fused to the dental construct substrate (118) by heating. During heating, the wax layer and the film or paper substrate (if left on) are burnt off. Preferably, no toxic substances remain after the heating step. Using only a wax-based substrate is particularly ideal here because wax does not leave toxic materials behind when burnt.

Preferably, the melting temperature between the decal and either the film or paper substrate or the wax-based substrate is greater than 100 degrees Fahrenheit (° F.). Generally, the temperature difference should be between 120° F. and 300° F. Preferably, the melting temperature difference is between 150° F. and 200° F. This ensures that no significant melting occurs within the image layer of the decal, especially during subsequent conditioning steps. At a temperature difference of less than 100° F., the image layer may melt and lead to small distortions of the image.

Additionally, a sealant layer may be disposed over the decal (120) once the decal is fused to the dental construct substrate. But, a person of ordinary skill in the art will readily recognize that the sealant layer may also be a different material. The temperature for conditioning the image layer to the dental construct substrate, for thermal curing or hardening, is generally higher than the temperature used for conditioning the sealant layer. The difference in temperature between fusing the image to the dental construct substrate (118) and conditioning the sealant layer (120) should be greater than 100° F. The general temperature difference should at least be in the range of 120° F. to 300° F. Preferably, the temperature difference should be more in the range of 150° F. to 200° F. At a temperature difference of less than 100° F., the image layer may be excessively melted and lead to small distortions of the image. At larger temperature differences, the lower temperature may melt some components of the image layer, but not enough to distort the image. In composite and resin applications temperatures do not play a roll since the decal is cured with light.

In another embodiment, the computer generated image may be directly printed to the dental construct substrate (112) using known printing methods, including those printing methods known to print to non-flat surfaces. In one embodiment, a ceramic layer may be placed adjacent to the dental construct substrate (122) and the image may be printed on to the ceramic layer (124). This ceramic layer may be the same as or similar to a covering or sealant layer of the substrate, if the substrate is ceramic. The ceramic layer may also be a thin white color that may easily be colored by pigments to blend in with the dental restoration base and surrounding color and characteristics. The print may be printed to the entire tooth or just a portion of the tooth and, accordingly, the desired characteristics may be printed in one pass or multiple passes. Similarly, the thickness of the printed image preferably remains thin relative to the thickness of the tooth or dental restoration. In this case, the thickness of the image is preferably between 3 and 10 microns.

The process described herein may also use a hybrid decal wherein the color and characteristics of the decal are partially imparted via printing to a ceramic sheet and partially imparted via direct printing. Ultimately, the image layer, although thin and unobtrusive to the restoration process, imparts desired color and characteristics of the natural tooth by adding depth and three-dimensional visual effects.

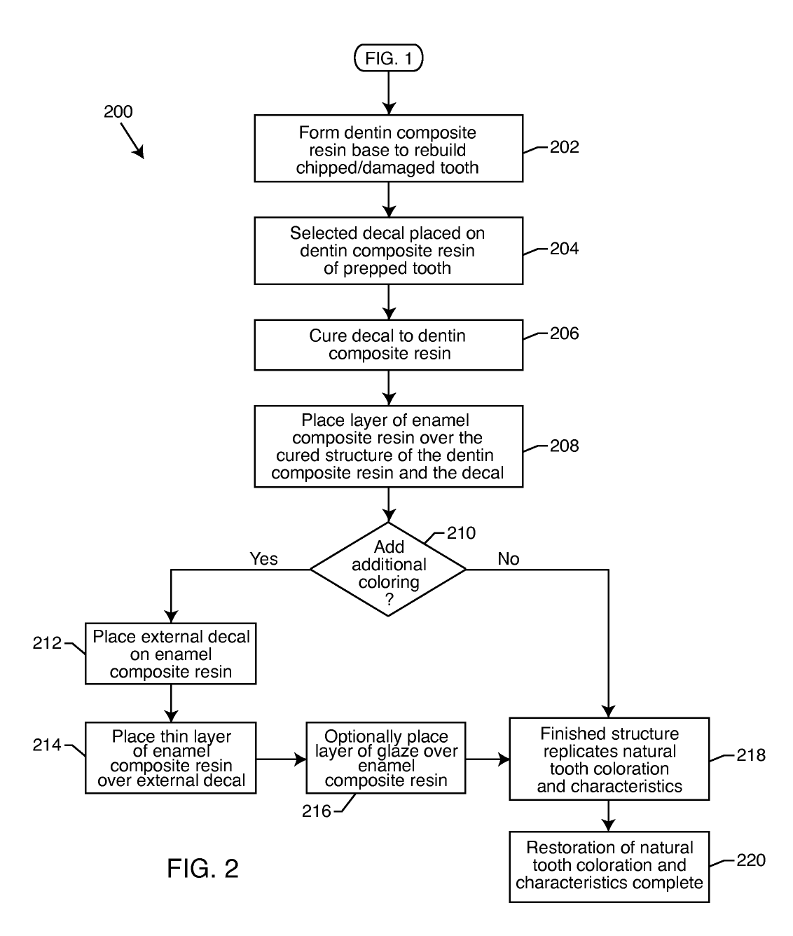

Replica images of the artistically computer generated images described in step (102) may be categorized in a chart and/or catalog as samples for viewing by dentists and/or patients (126). The catalog may include a variety of styles, colors and stylizations for the dentist to share with the patient in preparation for creating a dental restoration. The catalog is representative of the types of decals that are available at the dental laboratory, or any other facility where dental restorations are fabricated. Alternatively, a set of distributable pictures of the decal images may be created for viewing by the patient prior to commencement of the actual restoration. Accordingly, the dentist and/or patient may select a replica image or multiple replica images having the desired color and characteristics for the tooth or tissue restoration by using a characterization guide (128). The selected image or image bearing decal may have the appropriate color and transparency characteristics that match the natural oral cavity coloration and characteristics the patient desires. The dentist then communicates the selected decals to the dental lab technician at a facility that manufacturers the tooth restoration. From this information, the dental lab technician selects a decal, or multiple decals, matching the replica image, or multiple replica images, selected by the dentist and patient (130). The lab technician chooses the corresponding decals from the artist decal sheet to match the chosen images selected by the dentist and/or patient (128). The lab technician or dentist then creates the dental appliance according to the needs of the patient (132), as more specifically described in the flowcharts in FIGS. 2, 5, 9 and 13. Of course, the selected decal may include a standard or stock decal, a decal representative of a model tooth or a decal (modified or unmodified) created by photographing the oral cavity of the patient.

For standard or base decals, a reference catalog provided to dentists helps ensure the consistency and accuracy of selecting a particular style decal needed for the tooth restoration. Manufacturers and laboratories may have corresponding transparent decals that match the replica images selected by the dentist and/or patient. The decals are applied to the selected dental appliance. This method increases the aesthetic predictability of the appearance of the tooth restoration and virtually eliminates the difficult task of artistically mimicking the natural color and characterization of the oral cavity, one patient at a time. The dental restoration process and resultant apparatus disclosed herein also reduces the need for training technicians to fabricate artistically realistic tooth restorations and transforms the manufacturing process into a much simpler technique, especially for ceramic, acrylic or composite teeth manufactured for use with dentures. As a result, manufacturers are able to reduce the cost of tooling as multiple mold (more than two) layering of the denture teeth will no longer be needed, thereby simplifying the methods of denture tooth fabrication.

FIG. 2 illustrates a process for restoring a natural tooth, due to breakage, chipping or grinding (200). The first step is to apply a dentin composite resin to rebuild the chipped and/or damaged tooth (202). The dentin composite resin may also form the base of the tooth. The dentin composite resin varies in coloration, but is commonly some shade of dentin. For a damaged natural tooth (202), the dentin composite resin may be placed in an appropriate location to create a fairly flat platform to allow the decals to conform to the surface thereof. In direct image application, this facilitates direct printing of the image on to the dental construct substrate. Curing the dentin composite resin may be accomplished by any one of several polymerization processes.

The dentin composite resin may be cured using light emitted a specific wavelength. In one embodiment, the curing light may have wavelengths within the range of 390 nm to 470 nm. A composite resin composition may be cured by the light within these wavelengths because a mixture of chemical catalyst in the composite resin composition is reactive to light within this wavelength range. Such catalysts may include Camphorquinone (CQ), which absorbs light at wavelengths of approximately 465 nm, or phenyl-propanedione (PPD), which absorbs light at wavelengths of approximately 390 nm. The light source may include lamps, arc lamps (e.g. a halogen-based light source), semiconductor light emitting devices, light-emitting chips such as LEDs, solid state LEDs or LED arrays, fluorescent bulbs, etc. When exposed to the light source emitting the correct wavelength of light, the composite resin cures or hardens. A light-based hardening process may be accomplished directly (i.e. chairside) or indirectly (i.e. non-chairside). Chairside curing may be accomplished using hand held curing lights such as the Flashlight Magna™ sold by Discus Dental, LLC of Culver City, Calif.

The non-chairside side process may include using light, pressure or heat to further harden the dentin composite resin. Pressure may be used to remove air gaps within the composite resin material to increase the density thereof, thereby forming a harder structure than if only hardened by light. Accordingly, light may be used to further harden the structure by reacting with a chemical catalyst in the composite, as noted above. In another alternative embodiment, the light and pressure are combined with heat. Here, the dentin composite resin may achieve a high degree of polymerization. Chemical catalysts in the composite resin react and harden at high temperatures. Alternatively, the heating and pressurizing processes may be used exclusively without light. Different chemical compounds may be used in the composite resin depending on the desired polymerization process. Accordingly, the dentist or dental technician would endeavor to select the corresponding chemical catalyst that hardens in response to light, pressure or heat, or all.

In another embodiment, a dentist or dental technician may decide to use a combination of chairside and non-chairside processes. For example, a dental appliance such as a veneer may be chosen from a kit containing multiple prefabricated non-custom dental veneers having different characteristics (e.g. decals having different shading and/or intensity configurations). The appliance may include a plurality of composite layers at least partially uncured. These composite layers may be of the same colors and characteristics or they may be of different colors or characteristics—especially after the composite layers are fully cured. The composite layers are prearranged relative to one another so as to provide a desired overall appearance, shade, and intensity having natural oral cavity characteristics. Additional coloration and characteristics may be added by placing the decals on top of the composite layers or below at least one of the composite layers. The uncured composite layers may be manipulated for added customization while the dental practitioner works on the patient chairside. Such an option is available chairside so the dental practitioner can provide shade matching and improved natural appearance. This enables, but does not require, the dental practitioner to manipulate the stock veneer (or other general dental appliance) according to the characteristics of adjacent natural teeth and/or appliances.

The dental practitioner can work directly with the patient to select a dental appliance that closely matches the desired oral cavity characteristics of the patient, as described above, while still be able to manipulate those characteristics to ensure consistent shading between multiple restorations and between restorations and natural teeth. In other words, the final restoration is not limited to the color and characteristics of the stock dental appliance. The particular dental appliance or a set of dental appliances may be selected, and optionally further manipulated, so as to provide a desired color shade and intensity to a particular tooth or oral cavity once installed. The particular dental appliance(s) may also be selected for the ability to provide consistent shade matching to adjacent natural teeth and/or consistent shade matching to other adjacent dental appliances. One or more prefabricated non-custom dental appliances may be selected, manipulated, and bonded in a single appointment chairside. Furthermore, the prefabricated non-custom dental appliances may eliminate the need for custom appliances, which may be inherently difficult to make. With some custom dental appliances, it is nearly impossible to achieve consistent matching of the dental appliance relative to adjacent natural teeth and/or other adjacent dental appliances.

As shown in FIG. 2, the selected decal may be placed on the hardened dentin composite resin of the prepped tooth (204). The decal may also be placed on the partially cured or hardened composite resin, as described above. The decal may then be cured to the dentin composite resin (206). To complete the initial contour and shape of the restored tooth, a layer of enamel composite resin is placed over the cured structure of the dentin composite resin and the decal (208).

The dentist must then decide whether to add additional coloring (210). When adding additional coloring, an external decal may be placed over the layer of enamel colored composite resin (212) to add the necessary stylizations to replicate the natural tooth colorizations and characteristics. Next, a thin layer of enamel composite resin is placed over the external decal (214). Thereafter, an optional layer of glaze is placed over the composite resin (216) to protect the dental restoration from possible long-term deterioration. The glaze is applied primarily to fill micro holes in the enamel composite resin and to enable the dentist to polish the outer surface of the tooth restoration. Decals can be used on external surfaces to achieve the desired colorization results. This application may also be used for pressable or milled ceramics for any ceramic restoration (tooth and oral tissue, such as mucosal tissue) that requires coloration variations where additional stylizations may enhance the overall aesthetic results of the tooth or tissue restoration, as further described herein. The completed structure replicates the natural tooth coloration and characteristics (218) when the restoration of the natural tooth coloration and characteristics is complete (220).

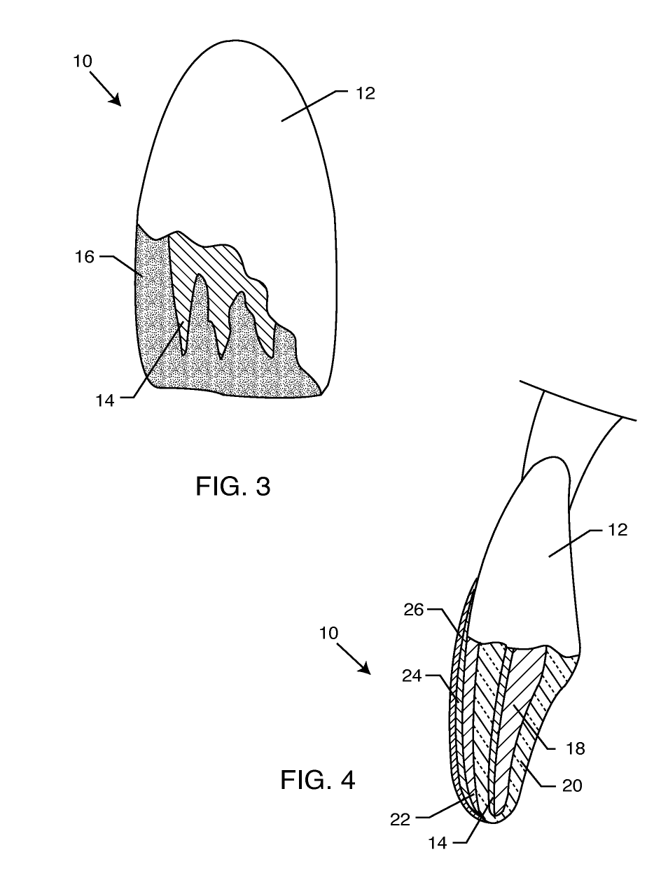

FIGS. 3 and 4 illustrate a tooth restoration 10 of a chipped tooth 12 having a decal 14 therein. FIG. 3 is a front view of the tooth restoration 10 wherein a portion of the chipped tooth 12 is filled in with a filler 16. As shown in FIG. 4, the filler 16 comprises a dentin composite resin base 18 having the decal 14 formed thereon. Accordingly, after the decal is cured as described in step (206), an enamel composite resin 20 is disposed over the decal 14 and the dentin composite resin base 18. The filler 16 is designed to fix a cracked or broken portion of the tooth 12, generally shown in FIG. 3. The decal 14 is visible through the enamel composite resin 20 such that the colorization and characteristics of the decal 14 are viewable as shown through the front side of the chipped tooth 12 in FIG. 3. An additional external decal 22 may be disposed on top of the enamel composite resin 20 for additional coloring or characteristics. The external decal 22 may be protected by applying a thin layer of enamel composite resin 24 thereover. Optionally, a substantially transparent glaze 26 may be applied to the thin layer of enamel composite resin 24 for further protection thereof.

In an alternative embodiment, the tooth restoration 10 of FIGS. 3 and 4 could be used to create an oral cavity model. The process for making the model is generally illustrated in the flowchart in FIG. 2. The model comprises similar compositions as the tooth restoration illustrated in FIG. 4. Therefore, the dentin composite resin base 18, the enamel composite resin 20, the decal 14 and the thin enamel composite resin layer 24 would extend the entire length of the tooth restoration 10 as shown in partial form in FIG. 4. Likewise, the external decal 22 and optional glaze 26 should also extend the length of the tooth. The decal 14 or the external decal 22 may be applied as a whole sheet or as a series of partial sheets in sections of the front, back and bottom portions of the tooth. This process further ensures accurate replication of natural tooth colorization and characteristics.

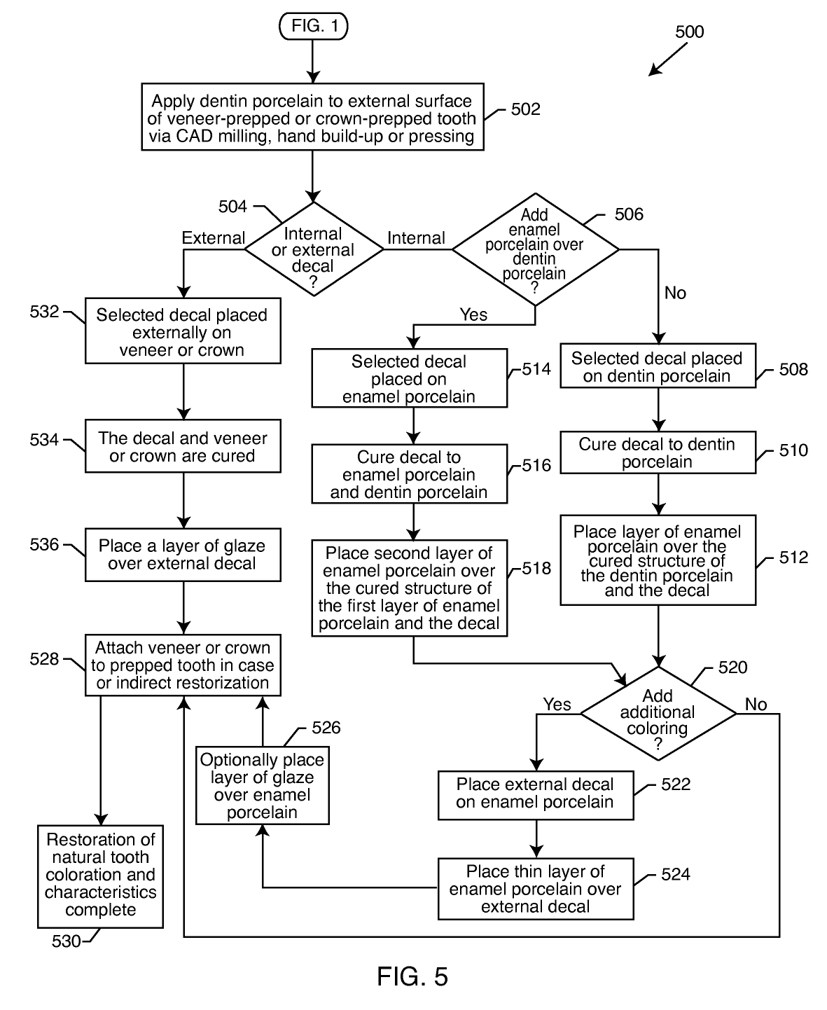

The dental restoration process and resultant apparatus described herein may be applicable to other dental structures, including crowns and composite resin-based or porcelain-based veneers. FIG. 5 illustrates a process for creating a tooth restoration using a decal and a porcelain-based veneer or a crown (500). The first step is to apply dentin porcelain to an external surface of the veneer-prepped or crown-prepped tooth via CAD milling, hand build-up or pressing (502). Step (502) may involve shaving a portion of the existing tooth enamel down to make room for the thickness of the veneer. Prepping a tooth for veneer placement is well-known in the art. Alternatively, the dentin porcelain may be applied to an unprepped tooth, such as for use with a crown.

The next step is to determine whether the decal will be placed internal or external in the tooth restoration (504). For internal placement, it must be decided whether to add an enamel porcelain layer to the tooth restoration before application of the decal (506). In one embodiment, the enamel porcelain layer is not needed and the selected decal is placed directly on the dentin porcelain of the prepared tooth (508). Internal placement of the decal on the tooth restoration in this embodiment is similar to the process disclosed in FIG. 2. The decal is cured to the dentin porcelain (510) by any of the previously described methods, such as firing in an oven. Then, a layer of enamel porcelain is placed over the dentin porcelain and decal (512). Sometimes only a small layer of dentin porcelain is required because the tooth may not be chipped as previously described and shown in FIGS. 3 and 4. In an alternative embodiment, determining to first add enamel porcelain over the dentin porcelain during step (506) necessarily requires that the selected decal be placed on the enamel porcelain (514) instead of being placed on the dentin porcelain (508). In this embodiment, the decal is cured together with the enamel porcelain and the dentin porcelain (516). A second layer of enamel porcelain is placed over the cured structure of the first layer of enamel porcelain and the decal (518).

In accordance with both of the above-described embodiments, the dentist or technician next determines whether to add additional coloring (520) to the tooth restoration. In the case that additional coloring is desired, an external decal is placed on the enamel porcelain (522). Next, a thin layer of enamel porcelain is placed over the external decal (524). Optionally, a layer of glaze may then be placed over the enamel porcelain (526) for further protection of the dental restoration. The external decal is placed over the enamel porcelain to further enhance the natural aesthetic look of the restored tooth. Thereafter, the prepped tooth is ready to have the veneer or crown attached thereto in the case of an indirect restoration (528). The restoration of the natural tooth coloration and characteristics is then complete (530) for that tooth once the veneer or crown is attached using methods known in the art. The steps for creating a tooth restoration with a decal and a porcelain-based veneer (500), and specifically steps (502)-(526), may be repeated for multiple teeth. Often it is desirable to restore more than one tooth with veneers and other types of porcelain restorations to ensure color consistency and characteristics among the restored teeth and non-restored teeth.

Alternatively, the process for creating a tooth restoration with a decal and a porcelain-based veneer or crown (500) may include the step of placing the decal external to the tooth restoration (532). As shown in FIG. 5, after deciding to use an external decal (504), the selected decal is externally placed on the veneer or crown (532) before attachment to a natural tooth. Next, the decal is cured with the veneer or crown (534). Thereafter, a layer of glaze (536) is placed over the external decal for protection thereof. Accordingly, the veneer or crown is then attached to the prepped tooth (528). The restoration of the natural tooth coloration and characteristics is then complete (530). Similarly, steps (502)-(536) may be repeated for each veneer, crown or bridge the patient requires.

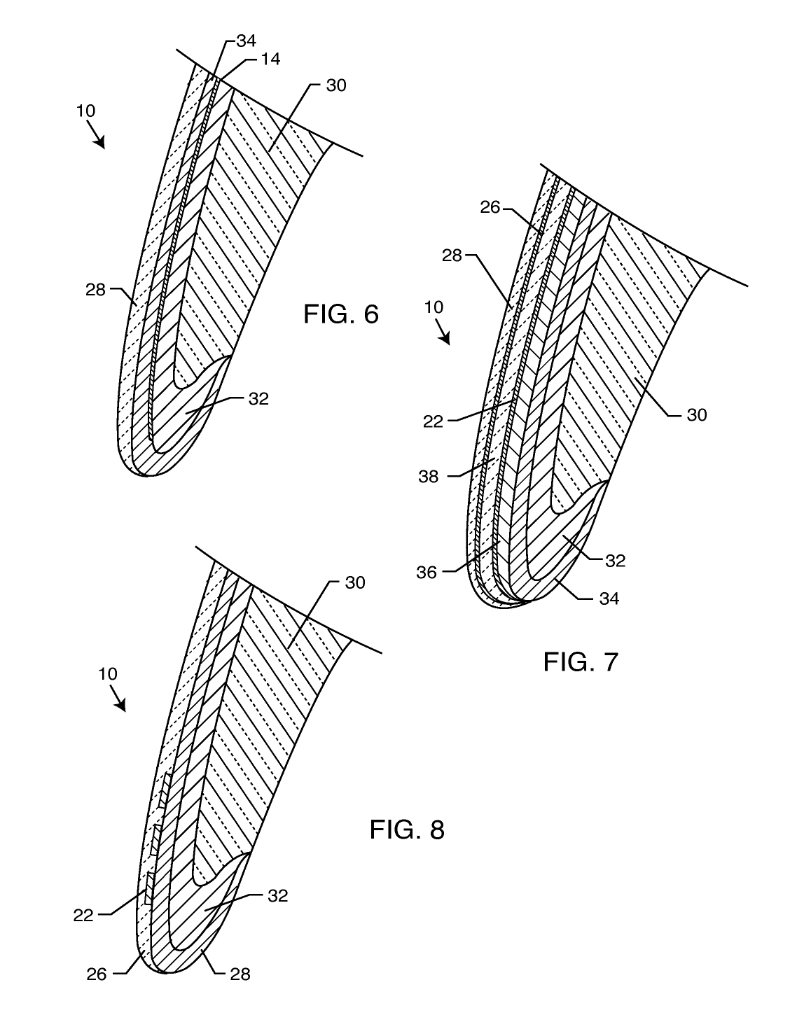

FIGS. 6-8 are cross-sectional side views of a tooth restoration 10 having a porcelain-based veneer 28. FIG. 6 illustrates the tooth restoration 10 having an internally placed decal 14. As shown, a veneer prepped tooth 30 has a dentin porcelain base 32 applied along the exterior thereof. The veneer-prepped tooth 30 may be reduced slightly in size (e.g. 0.5 millimeters) to make room for the veneer 28 and the corresponding dentin porcelain base 32, an enamel porcelain layer 34 and the decal 14. Accordingly, the decal 14 is applied to the external front layer of the dentin porcelain base 32. The enamel porcelain 34 is thereafter applied to the external surface of the decal 14 and the dentin porcelain base 32. Lastly, the veneer 28 is attached to the external portion of the enamel porcelain 34 of the tooth restoration 10 illustrated in FIG. 6. The decal 14 is visible through the enamel porcelain 34 and the veneer 28.

FIG. 7 illustrates an alternative embodiment of the tooth restoration 10 illustrated in FIG. 6. The tooth restoration 10 in FIG. 7 similarly includes the veneer-prepped tooth 30 and the dentin porcelain 32. In this embodiment, however, the enamel porcelain 34 is applied directly to the dentin porcelain 32 before application of the decal 14. The decal 14 is then applied directly to the enamel porcelain 34. Thereafter, a second layer of enamel porcelain 36 is applied over the decal 14 and any exposed portion of the enamel porcelain 34. The second layer of enamel porcelain 36 provides the necessary long term protection for the decal 14. An optional glaze 26 may be applied to the second layer of enamel porcelain 36 for further protection thereof. The glaze 26 primarily fills micro holes in the enamel porcelain and enables the dentist to polish the outer surface of the tooth restoration. The veneer 28 is then applied to the second layer of enamel porcelain 36 in a similar manner as shown and described with respect to FIG. 6. Additionally, the external decal 22 may be applied to the second layer of enamel porcelain 36 before application of the veneer 28. In this embodiment, an external enamel porcelain 38 is applied to the external decal 22, according to the steps described above. Again, the optional glaze 26 may be applied to the external enamel porcelain 38 for further protection thereof. Once the dentist determines that the appropriate colorization and characterization of the tooth are adequate, the veneer 28 is attached thereto according to the processes described above.

FIG. 8 illustrates attachment of the porcelain-based veneer 28 to the veneer-prepped tooth 30 utilizing only the external decal 22. The veneer-prepped tooth 30 has the dentin porcelain base 32 applied directly thereto. The veneer 28 is eventually applied directly to the dentin porcelain 32, but should first receive the external decal 22. In this regard, the external decal 22 is applied to the exterior of the veneer 28 pre-application to the veneer-prepped tooth 30. The external decal 22 and the veneer 28 are then cured together. A glaze 26 is applied to the exterior of the veneer 18 to protect the external decal 22 and the veneer 28 cured thereto. The veneer 28 having the external decal 22 and the glaze 26 thereon is thereafter attached to the dentin porcelain 32 and the tooth 30 by any method known in the art. The attached veneer 28 then displays the desired coloration and characteristics of the natural tooth via the external decal 22.

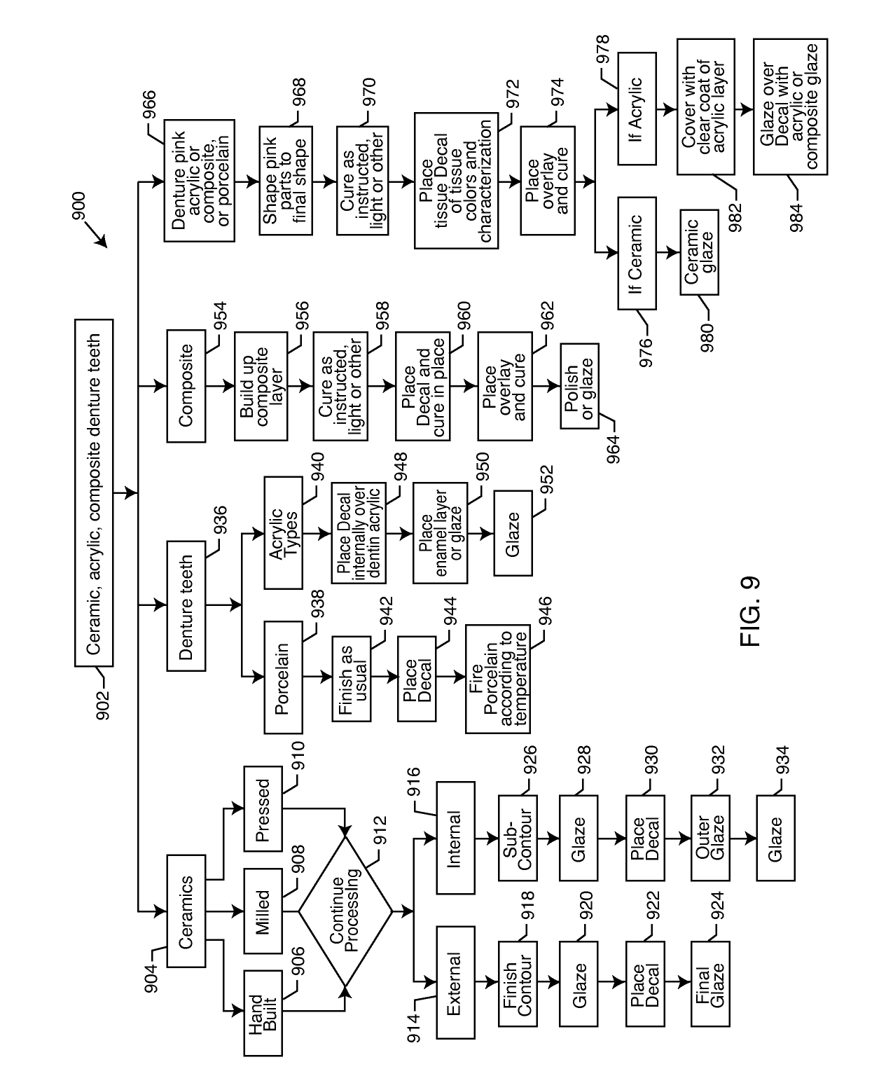

The decal 14 may also be used with ceramic, acrylic or composite teeth for placement in dentures, as generally shown in the flowchart in FIG. 9. In most instances, the steps in FIG. 9 may be accomplished by a ceramic, acrylic or composite tooth manufacturer, rather than a dentist or lab technician. Multiple decals may be needed to replicate the coloration and characteristics of multiple teeth that the dentures will replace. The use of decals in the fabrication phase of ceramic, acrylic or composite teeth for use in dentures simplifies the production process and provides more realistic dentures. The fabricated ceramic teeth contain better aesthetic coloration and characteristics.

The process for forming a ceramic, acrylic or composite denture tooth for placement in dentures (900) starts by forming a dentin ceramic, acrylic or composite denture tooth via CAD/CAM milling, liquid-powder build-up, or pressing (i.e. a pressable) (902). With a ceramic denture tooth (904), it may be either hand built (906), milled (908), or pressed (910). After this has been continuously processed (912), the next step is to determine whether the decal will be placed external (914) or internal (916) in the denture tooth (904). In the event that external coloring is desired, a finish contour (918) is first created, with a glaze (920) on top of the finish contour (918). The decal is placed (922) and then a final glaze (924) is placed on top of the decal. The finished ceramic tooth should accurately replicate natural tooth coloration and characteristics. Internal placement (916) of the decal on the denture tooth is similar to the process disclosed in FIG. 5. A sub-contour (926) is applied, with a glaze (928) overtop to protect the sub-contour (926). A decal is placed (930) over the glaze (928), and now an outer glaze (932) is applied along with another glaze (934).

With denture teeth (936), they may be made from either porcelain (938) or from an acrylic type (940). With the porcelain type (938), a usual finish (942) is applied first and then the decal placed (944). The porcelain is then fired according to appropriate temperatures (946). With the acrylic type (940) denture teeth, the decal is placed internally over the dentin acrylic (948). Next, an enamel or glaze layer (950) is applied. Then a final glaze is applied (952).

With composite teeth (954), a composite layer (956) is first built up. Light is then typically used to cure (958) the composite layer (956). A decal is then placed and cured (960). An overlay is then placed on the decal and cured as well (962). Finally, either a polish or a glaze layer (964) can finish the teeth.

Denture teeth can be made from a denture pink acrylic, composite or porcelain material (966). First, the pink material is shaped to the final shape (968). Then the pink material is cured with light or various other means (970). Next, a tissue decal is placed which resembles the tissue, colors, and characterization of real tissue (972). An overlay (974) is then placed over the tissue decal and cured. If the material used is ceramic (976), a final ceramic glaze (980) is used. If the material is acrylic (978), then a clear coat layer of acrylic is applied (982) with a final glaze layer of acrylic or composite glaze (984).

The process illustrated in FIG. 9 is tremendously advantageous over current practices. Present technology uses sophisticated and expensive tooling that provides limited choices as to style or characterization. Using the aforementioned internal decals provides an inexpensive means for fabricating a greater variety of styles and characterizations.

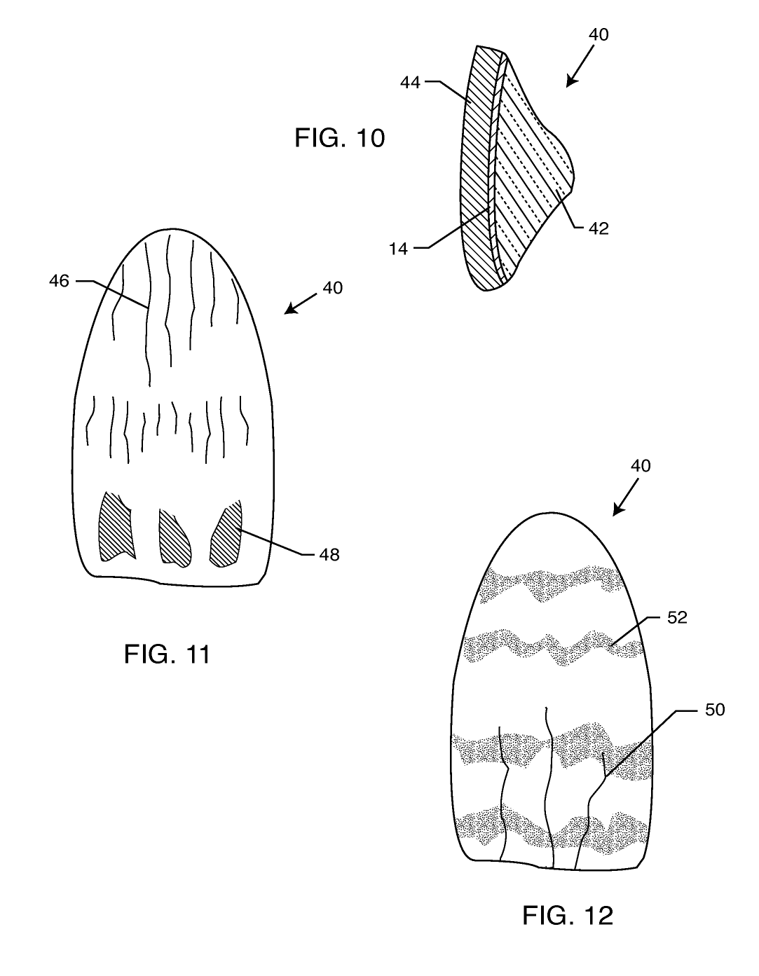

FIGS. 10-12 illustrate a sample denture tooth 40 for placement in dentures. FIG. 10 illustrates a cross-sectional view of the denture tooth 40 comprising a dentin base 42 having the decal 14 placed thereover and protected by an enamel material 44. The stylizations of the internal decal 14 placed between the dentin base 42 and the enamel material 44 are visible through the enamel material 44. FIG. 11 illustrates a front view of the denture tooth 40 having a plurality of details therein. For example, the denture tooth 40 includes a set of detail lines 46 and lobes 48. As more specifically shown in FIG. 12, the detail lines 46 may include a set of crazing lines 50 or white stains 52. In each of the embodiments illustrated in FIGS. 10-12, the denture tooth 40 has the decal 14 placed internally. The details illustrated in FIGS. 11 and 12 may come in many different types of stylizations, as previously described and listed. Moreover, the decal 14 may be placed externally, as described above. The decal may also be used in dentures with composite resin or acrylic-based teeth in addition to the ceramic-based teeth.

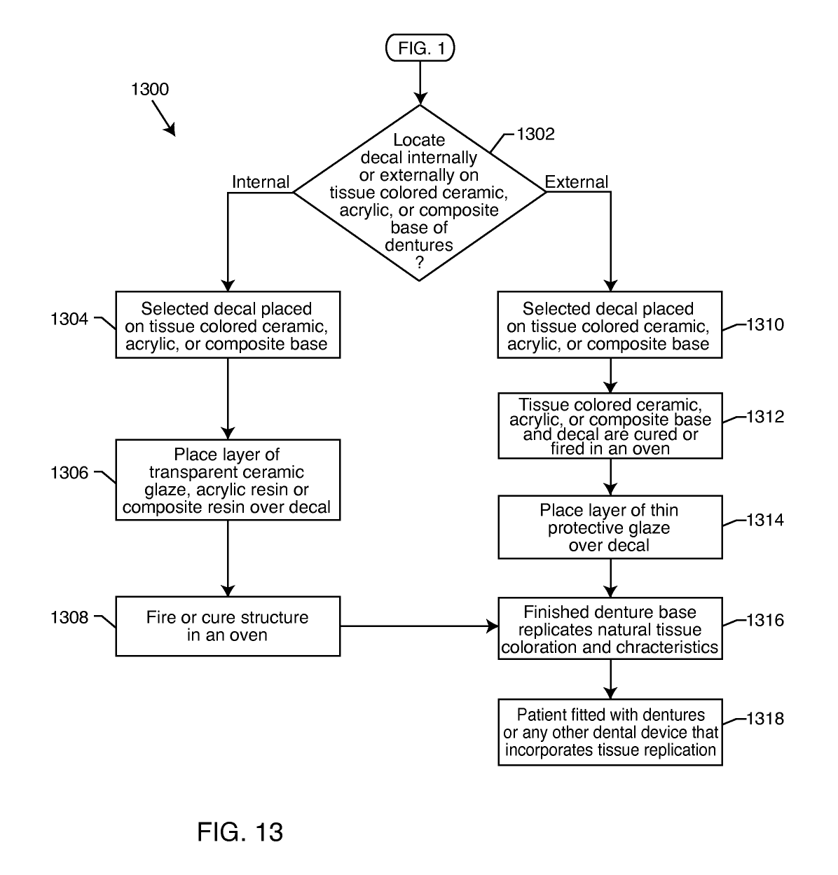

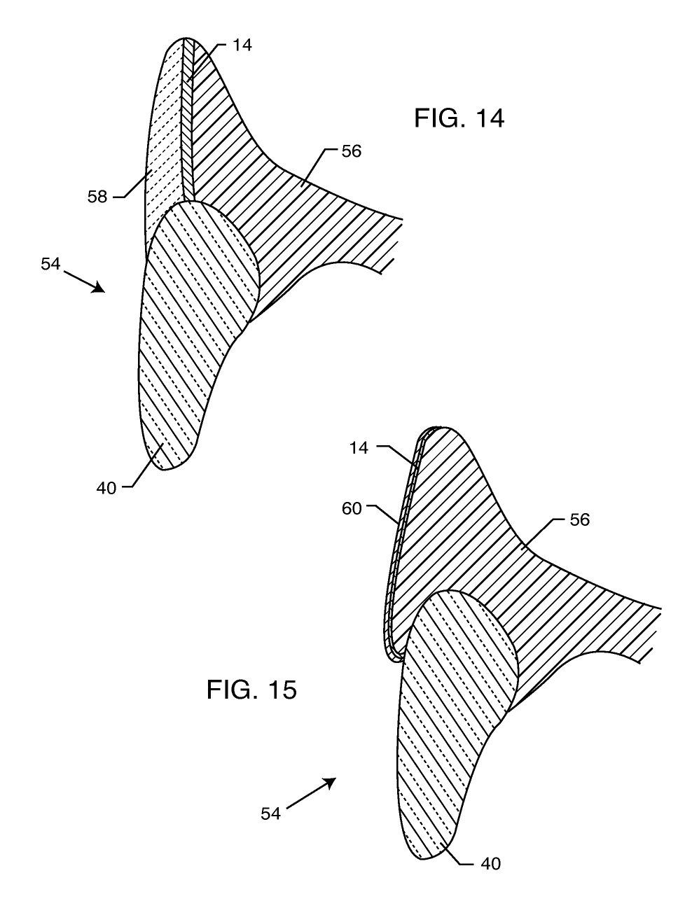

FIG. 13 illustrates the general process for incorporating a decal in a dental appliance for replicating the natural color and characteristics of oral tissue (1300). First, a lab technician must determine whether the decal is to be located internally or externally on a tissue colored ceramic, acrylic or composite base (1302). An internally located decal is placed directly on the tissue colored ceramic, acrylic or composite base (1304) in the dental appliance. These decals may, alternatively, be used to represent soft tissue coloration and characteristics and can be used in conjunction with veneers, crowns, bridges and other implants. The decals mimic the tissue stylizations applied to dental restorations when soft tissue prosthesis is necessary. A layer of transparent ceramic glaze, acrylic resin or composite resin is then placed over the decal (1306). The tissue colored acrylic resin base and the decals are then fired or cured according to material specifications (1308). The curing process may be accomplished by any method known in the art. External placement of the decal requires that the selected decal be placed on the tissue colored ceramic, acrylic or composite base (1310). This structure is also hardened by curing or firing (1312). Next, a thin layer of protective glaze is placed over the external decal (1314). The protective glaze provides insulation of the decal from the environment and protects against wear. The result of steps (1308) and (1314) is that the finished dental appliance replicates the natural tissue coloration and characteristics of the oral cavity (1316). The patient is then fitted with the dentures or any other device that incorporates tissue replication (1318). In this embodiment, the internal or external decals mimic the oral tissue coloring, which may comprise blood vessels, tissue covering, musculature areas, tendons, tissue colors or bony anatomy changes. The steps disclosed in FIG. 13 may also be combined with those steps disclosed in FIG. 9 to provide dentures having both natural looking teeth (FIGS. 10-12) and oral tissue (FIGS. 14-15).

FIGS. 14 and 15 illustrate the internal and external placement, respectively, of the decal 14 in the oral tissue area of dentures. FIGS. 14 and 15 are cross-sectional views of a denture 54, generally. The dentures 54 include a tissue colored acrylic resin 56 adjacent to the previously described denture tooth 40. In FIG. 14, the decal 14 is placed internal in the denture 54 as sandwiched between the tissue colored acrylic resin 56 and a transparent tissue colored acrylic resin 58. The transparent tissue colored acrylic resin 58 allows the details of the decal 14 to be seen externally. Thus, the natural tissue coloration the decal 14 aims to display is visible. Alternatively, in FIG. 15 the decal 14 is external to the tissue colored acrylic resin 56 and is protected by a protective layer 60. Preferably the protective layer 60 is the previously described glaze.

As described above, an image of the desired color and characteristics may be printed directly to a decal on the dental construct substrate or may be disposed on a first layer of the dental reconstruction adjacent to the dental construct substrate. The decals printed are created from a photo, captured image or drawing to aesthetically mimic the internal and/or external coloration and characteristics of natural teeth and the internal and/or external coloration and characteristics of natural tissue surrounding tooth areas, such as papillae and mucosal tissue. The fabrication of the composite resin restorations, either directly or indirectly, includes placing a decal or part of a decal in a composite resin or ceramic fabrication to mimic the internal and external anatomical coloration of the oral cavity. Mimicking the natural color stylizations allows dentists to offer patients dental restorations having thin tooth and tissue coloration and characteristics that best matches the oral cavity aesthetics of the patient.

The decals can create a three-dimensional natural looking tooth restoration by placing the decals in multiple layers of composite resin or ceramic material. Alternatively, the multiple decals may be stacked on one another or placed intermittently in the front, bottom or rear portions of the tooth restoration. The key aspect is that the decal replaces any need for drawing tooth or tissue coloration and characteristics to the dental restoration. The composite resin, ceramic, porcelain or glaze protects the decal to increase durability. The decals described herein may be placed in areas where composite resin layering, ceramic layering and acrylic resin layering are being used. Such layering may be used in the fabrication of denture teeth, tooth restorations or mucosal tissue replication. The decals or images may also be used with partial veneers, crown and bridge applications and chipped or broken teeth as well as non-prepared teeth for veneering purposes.

Although several embodiments have been described in some detail for purposes of illustration, various modifications may be made to each without departing from the scope and spirit of the invention. Accordingly, the invention is not to be limited, except as by the appended claims.

What is claimed is:

1. A process for making a dental restoration, comprising the steps of:
forming an image representing a natural oral cavity characteristic;
transferring the image to a dental construct base;
conditioning the image and the dental construct base;
disposing a sealant over at least a portion of the image or over at least a portion of the dental construct base; and
finishing the sealant with the image or the dental construct base to create a dental restoration having desired oral cavity color and characteristics.

2. The process of claim 1, wherein the transferring step includes the step of printing the image to the dental construct base.

3. The process of claim 1, including the step of printing the image to a substrate attachable to the dental construct base.

4. The process of claim 3, wherein the substrate comprises a film, a paper, a ceramic, or a wax base substrate.

5. The process of claim 1, wherein the conditioning step includes the step of heating the image and the dental construct base to a first temperature.

6. The process of claim 5, wherein the finishing step includes the step of heating the sealant and the image or the dental construct base to a second temperature lower than the first temperature.

7. The process of claim 6, wherein the second temperature is at least approximately 120 degrees Fahrenheit lower than the first temperature.

8. The process of claim 1, wherein the forming step includes the step of creating the image on a computer.

9. The process of claim 8, wherein the computer-based image comprises a computer-generated image, a photograph, or an imported artistic drawing.

10. The process of claim 9, including the step of digitally modifying the computer-generated image, the photograph or the imported artistic drawing.

11. The process of claim 1, including the step of creating a distributable picture of the image.

12. The process of claim 11, including the step of selecting an image with a characterization guide based on the distributable picture.

13. The process of claim 1, wherein the conditioning step includes the step of curing the image and the dental construct base with a high intensity light or fusing the image to the dental construct base.

14. The process of claim 1, including the steps of attaching a secondary image over the sealant and glazing the secondary image.

15. The process of claim 1, wherein the dental construct base comprises a composite resin, a veneer, a crown, an acrylic resin, a ceramic or a transparent acrylic resin.

16. A dental restoration, comprising:
a dental construct base;
a printed image imparted to the dental construct base and having a natural oral cavity characteristic, wherein the image is printed from a computer-based image; and
a sealant disposed over the image and at least a portion of the dental construct base.

17. The dental restoration of claim 16, wherein the computer-based image comprises a photograph, a computer-generated model image, or a drawing.

18. The dental restoration of claim 16, including a stock of standard computer-based images.

19. The dental restoration of claim 18, wherein the natural oral cavity characteristic is digitally painted to one of the standard computer-based images.

20. The dental restoration of claim 18, including a distributable picture for each of the standard computer-based images.

21. The dental restoration of claim 20, including a characterization guide for use with the distributable pictures in selecting a standard computer-based image.

22. The dental restoration of claim 16, wherein the dental construct base comprises a composite resin, a veneer, a ceramic, or an acrylic resin.

23. The dental restoration of claim 16, wherein the sealant comprises a composite resin, a transparent acrylic resin, a protective layer, a ceramic, or a glaze.

24. The dental restoration of claim 16, including a secondary image affixed to the sealant and a glaze disposed on the secondary image

25. The dental restoration of claim 16, wherein the image is printed directly to the dental construct base or printed to a film, a paper, a ceramic, or a wax substrate attachable to the dental construct base.

26. A process for making a dental restoration, comprising the steps of:
forming an image on a computer which represents a natural oral cavity characteristic, wherein the natural oral cavity characteristic comprises internal and external structures and coloration of teeth and oral cavity tissue;
printing the image to a dental construct base;
curing the image and the dental construct base at a first temperature;
disposing a sealant over at least a portion of the image or over at least a portion of the dental construct base; and
conditioning the sealant and the image or the dental construct base to a second temperature lower than the first temperature to create a finished dental restoration having desired oral cavity color and characteristics.

27. The process of claim 26, wherein the second temperature is at least approximately 120 degrees Fahrenheit lower than the first temperature.

28. The process of claim 26, wherein the forming step includes the step of fabricating a stock of standard images.

29. The process of claim 28, including the step of digitally modifying one of the standard images to attain the desired natural oral cavity characteristic.

30. The process of claim 26, including the step of creating a distributable picture of the image.

31. The process of claim 26, including the steps of attaching a secondary image over the sealant and glazing the secondary image and the sealant.

32. The process of claim 26, wherein the sealant comprises a composite resin, a transparent acrylic resin, a protective layer, a ceramic, or a glaze.

33. The process of claim 26, including the step of selecting the image with a characterization guide.

34. A dental restoration, comprising:
a dental construct base;
an image applicable to the dental construct base and having a natural oral cavity characteristic, the image being printed from a digital photograph, a computer-generated image, or a digitized drawing;
a distributable picture of the image;
a characterization guide matching the distributable picture with the image;
a sealant disposed over the image and at least a portion of the dental construct base;
a secondary image affixed to the sealant; and
a glaze disposed over at least a portion of the secondary image.

35. The dental restoration of claim 34, wherein the natural oral cavity characteristic comprises teeth, enamel, dentin, crazing lines, stains, veins, blood vessels, bony coloration, hyper-calcification, mucosal tissue or gum tissue.

36. The dental restoration of claim 34, wherein the dental construct base comprises a composite resin, a veneer, a crown, a ceramic, or an acrylic resin and the sealant comprises a composite resin, a transparent acrylic resin, a protective layer, a ceramic, or a glaze.
